(19) United States
(12) Patent Application Publication
(10) Pub. No.: US 2026/0192400 A1
(43) Pub. Date: Jul. 9, 2026

(54) LASER WORKING METHOD, APPARATUS, COMPUTER STORAGE MEDIUM, AND ELECTRONIC DEVICE

(71) Applicant: Shenzhen Creality 3D Technology Co., Ltd., Shenzhen (CN)

(72) Inventors: Huilin LIU, Shenzhen (CN); Mingwen LI, Shenzhen (CN); Fayang CAO, Shenzhen (CN)

(21) Appl. No.: 19/131,312

(22) PCT Filed: Oct. 23, 2023
(86) PCT No.: PCT/CN2023/125828

§ 371 Date: May 20, 2025

(30) Foreign Application Priority Data
Nov. 21, 2022 (CN) 202211451880.5

(51) Int. Cl. B23K 26/70; B23K 26/362

(52) U.S. Cl. CPC B23K 26/702; B23K 26/362

(57) ABSTRACT

A laser working method includes: obtaining working scenario information of a laser, the laser including a plurality of light sources having different laser characteristics; selecting, according to the working scenario information, a working light source from the plurality of light sources having different laser characteristics, and driving the working light source to emit light; and monitoring the working state of the working light source, and sending alarm information when it is detected that the working state is an abnormal state. An electronic device and a non-transitory computer storage medium are also provided.

The present application requires a priority of a Chinese patent application filed with the Chinese Patent Office on Nov. 21, 2022, with application No. 202211451880.5 and entitled “LASER WORKING METHOD, APPARATUS, COMPUTER STORAGE MEDIUM, AND ELECTRONIC DEVICE”, the entire contents of the Chinese patent application are incorporated by reference in the present application.

### TECHNICAL FIELD

This application relates to the field of intelligent laser engraving machines, and specifically, to a laser working method, an apparatus, a computer storage medium, and an electronic device.

### BACKGROUND

To meet user's demand for cutting capabilities, current civilian laser engraving machines including laser diode (LD) light source modules are designed with increasingly higher power. Since a power of a single semiconductor laser is limited, an incoherent spatial combination method is used to accumulate power of LD light sources to achieve a required power of the LD light source module. Currently, laser modules on the market use a series design of LD light sources with the same power to achieve a power superposition. Although this can meet a cutting power requirement, the LD light sources must emit light simultaneously under the series design. An output light spot is a result of a superposition of several light source spots, the output light spot is relatively large, which affects a thickness of engraving lines and ultimately leads to poor engraving results. Furthermore, due to single light emitting characteristics of light sources of the laser module, types of materials suitable for engraving and cutting are limited, which greatly restricts operating scenarios of the laser module.

In addition, since the LD light sources generate significant heat during operation, temperatures of the LD light sources may gradually rise during light emitting operation. If the LD light sources operate in an over-temperature and over-current state for a long time, it may cause irreversible damage to the LD light sources, resulting in machine's inability to operate normally and greatly reducing laser service life.

### SUMMARY

Accordingly, this application provides a laser working method, an apparatus, a computer storage medium, and an electronic device, which is capable of various operating scenarios, sending alarm information when an operating state of light sources is abnormal, and improving laser service life.

First aspect of this application provides the laser working method, the method includes: obtaining operating scenario information of a laser, the laser including a plurality of light sources with different laser characteristics; selecting one or more working light sources from the plurality of light sources with different laser characteristics in accordance with the operating scenario information of the laser, and driving the one or more working light sources to emit light, and monitoring operating states of the one or more working light sources and sending alarm information in response to the operating states of the one or more working light sources including an abnormal state.

Compared with the prior art, the embodiments of the present application have the following advantages. The laser is formed by the plurality of light sources with different laser characteristics. By obtaining the operating scenario information of the laser, the operating scenario of a laser machine including the laser can be determined, such as the operating scenario may be picture engraving, cutting, glass engraving, etc. Then, the one or more working light sources can be selected from the plurality of light sources with different laser characteristics in accordance with the operating scenario information, so that optimal engraving and cutting effects for the operating scenario can be achieved, and a practicality of the laser can be improved. By monitoring the operating state of the one or more working light sources and sending the alarm information when one or more working light sources are abnormal, the abnormal working light sources can be promptly dealt with, thereby avoiding irreversible damage caused by the working light sources remaining in an abnormal operating state for a long time, and improving the service life of the laser.

In some possible implementation manners, after obtaining the operating scenario information of the laser, the method further includes: obtaining a preset light source working temperature matched with the operating scenario information of the laser; monitoring the operating states of the one or more working light sources and sending the alarm information in response to the operating states of the one or more working light sources including the abnormal state includes: monitoring a working temperature of the one or more working light sources; and sending the alarm information when the working temperature of the one or more working light sources and the preset light source working temperature is not within a preset range.

By adopting above technical solution, a feasible method for monitoring the operating states of the working light sources is realized, and a reliability of the laser is improved.

In some possible implementation manners, a plurality of working light sources are selected, monitoring the working temperature of the one or more working light sources includes: monitoring the working temperature of each of the plurality of working light sources; sending the alarm information when the working temperature of the one or more working light sources and the preset light source working temperature is not within the preset range includes: sending the alarm information when the working temperature of at least one working light source among the plurality of working light sources is monitored higher than the preset light source working temperature.

By adopting above technical solution, a feasible method for monitoring the operating states of the plurality of working light sources is realized, and the reliability of the laser is improved.

In some possible implementation manners, after sending the alarm information, the method further includes: regarding the working light source whose working temperature is higher than the preset light source working temperature as an abnormal light source; and decreasing a light output power of the abnormal light source and increasing light output powers of other working light sources except the abnormal light source.

By adopting above technical solution, the light output power of each working light source can be dynamically adjusted, ensuring that each working light source is in a normal operating state and an overall light output power of the laser meets a requirement of the operating scenario, thereby ensuring a working effect of the laser.

In some possible implementation manners, after sending the alarm information, the method further includes: regarding the working light source whose working temperature is higher than the preset light source working temperature as an abnormal light source; and turning off the abnormal light source and increasing light output powers of other working light sources except the abnormal light source.

By adopting above technical solution, the light output power of each working light source can be dynamically adjusted, the abnormal light source is turned off, ensuring that other working light sources are in the normal operating state and an overall light output power of the laser meets the requirement of the operating scenario, thereby ensuring the working effect of the laser.

In some possible implementation manners, selecting the one or more working light sources from the plurality of light sources with different laser characteristics in accordance with the operating scenario information of the laser includes: obtaining a preset light source laser characteristics matched with the operating scenario information of the laser; and selecting the one or more working light sources with the same characteristics as the preset light source laser characteristics from the plurality of light sources with different laser characteristics.

By adopting above technical solution, a method of selecting working light sources is realized, which can ensure that the selected working light sources are suitable for the operating scenarios of the laser.

In some possible implementation manners, the light sources include laser diodes, the laser characteristics are selected from a group consisting of: wavelength, power, and beam shape.

Second aspect of this application provides a laser apparatus, the laser apparatus includes a light source module, a microcontroller module, a sensor module, and a power module; the light source module includes a plurality of light sources with different laser characteristics; the microcontroller module is configured for obtaining operating scenario information of the laser, selecting one or more working light sources from the plurality of light sources with different laser characteristics in accordance with the operating scenario information of the laser, and driving the one or more working light sources to emit light; the sensor module is configured for monitoring signals that characterize operating states of the one or more working light sources and sending the signals to the microcontroller module, the microcontroller module is further configured for sending alarm information in response to the operating states of the one or more working light sources including an abnormal state; and the power module is configured for supplying power to the light source module, the microcontroller module, and the sensor module.

Third aspect of this application provides a computer storage medium including computer instructions, when the computer instructions run on an electronic device, the electronic device is caused to execute the above-mentioned laser working method.

Fourth aspect of this application provides the electronic device, the electronic device include one or more processors and a storage medium, the storage medium is configured to store one or more instructions, when the one or more instructions run on the one or more processors, to cause the one or more processors to execute the above-mentioned laser working method.

Understandably, the laser apparatus provided in the second aspect, the computer storage medium provided in the third aspect, and the electronic device provided in the fourth aspect all correspond to the method provided in the first aspect. Therefore, the beneficial effects they can achieve, reference can be made to the beneficial effects of the corresponding method provided above, and details will not be repeated here.

### BRIEF DESCRIPTION OF THE DRAWINGS

In order to more clearly illustrate technical solutions in embodiments of the present application or in the prior art, the following briefly introduces accompanying drawings associated with the description of the embodiments or the prior art. Obviously, the accompanying drawings in the following description are merely those of the embodiments of the present application. For those of ordinary skill in the art, other drawings can be obtained in accordance with the provided drawings without creative effort.

FIG. 1 is a flowchart diagram of a laser working method provided by an embodiment of the present disclosure.

FIG. 2 is an operation flowchart diagram of a universal combined of n light sources provided by an embodiment of the present disclosure.

FIG. 3 is a structural diagram of the universal combined of the n light sources provided by an embodiment of the present disclosure.

FIG. 4 is a flowchart diagram of a working method of a laser provided by an embodiment of the present application.

FIG. 5 is a flowchart diagram of the working method of the laser provided by another embodiment of the present application.

FIG. 6 is a flowchart diagram of a dynamic power compensation of working light sources provided by an embodiment of the present application

FIG. 7 is a flowchart diagram of the working method of the laser provided by yet another embodiment of the present application.

FIG. 8 is a hardware module diagram of a laser apparatus provided by an embodiment of the present application.

FIG. 9 is a block diagram of the laser apparatus provided by an embodiment of the present application.

FIG. 10 is a block diagram of an electronic device provided by an embodiment of the present application.

### DETAILED DESCRIPTION

In order to more clearly understand the above purposes, features and advantages of the present application, the present application is described in detail below in conjunction with the drawings and the description of embodiments. It is understood that, embodiments of the present application and features in the embodiments may be combined with each other without conflict.

In the following description, many specific details are described in order to fully understand the present application, the described embodiments are only part of the present application, not all embodiments.

Unless otherwise defined, all technical and scientific terms used herein have the same meaning as those commonly understood by those skilled in the technical art of the present application. The terms used herein in the description of the present application are only for a purpose of describing the embodiments, and are not intended to limit the present application.

It should be further noted that, the term “including”, “comprising” or any other variation thereof is intended to cover non-exclusive inclusions, so that a process, a method, an article or an apparatus including a series of elements includes not only those elements, but also includes other elements not expressly listed, or also includes elements inherent in such process, method, article or device. Without further restrictions, an element limited by the statement “including a . . . ” does not exclude ab existence of another identical element in the process, method, article or apparatus including the element.

In the present application, “at least one” refers to one or more, “multiple/a plurality of” refers to two or more than two. “and/or”, describing the association relationship of the associated object, indicates that there may be three relationships, for example, A and/or B may mean: the existence of A alone, the existence of A and B at the same time, the existence of B alone, where A, B can be singular or plural. The terms “first”, “second”, “third”, “fourth” etc. (if exist) in the embodiments, claims, and drawings of the present application are used to distinguish similar objects, and are not used to describe a specific order or sequence.

In an embodiment of the present application, the words “for example” or “such as” are used to indicate as examples, illustrations or illustrations. Any embodiment or design described as “for example” or “such as” of the present application shall not be construed as being preferred or more advantageous than other embodiments or designs. The use of words such as “for example” or “such as” is intended to present a concept in a concrete way.

In order to facilitate the embodiments, some concepts related to the embodiments of the present application are given exemplary descriptions for reference.

Lasers are devices capable of emitting laser light. Classified by working mediums, lasers can be divided into four major categories: gas lasers, solid lasers, semiconductor lasers, and dye lasers. Light sources are laser diode (LD) light sources. A physical structure of a LD is that a layer of optical-active semiconductor is arranged between junctions of a light emitting diode. After an end-face of the semiconductor is polished, the end-face has a partial reflection function, thus forming an optical resonant cavity.

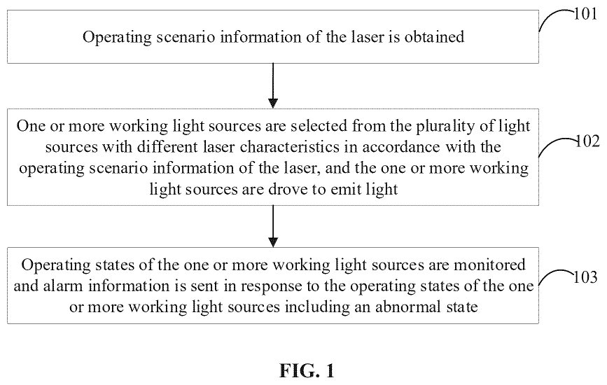

FIG. 1 illustrates an embodiment of a laser working method. The method can be applied in a laser, the laser may include a plurality of light sources with different laser characteristics. Referring to FIG. 1, the method may include the following blocks.
In block 101: operating scenario information of the laser is obtained.

In one embodiment, the operating scenario information of the laser may include: picture engraving and printing scenarios, cutting scenarios, glass engraving scenarios, etc. The embodiments of the present application do not limit scenario types included in the operating scenario information. The operating scenario information can include any usage scenarios in which the laser can operate.

In one embodiment, operating scenarios can be set by a user, and the laser can obtain information of the operating scenario (operating scenario information) set by the user.
In block 102: one or more working light sources are selected from the plurality of light sources with different laser characteristics in accordance with the operating scenario information of the laser, and the one or more working light sources are drove to emit light.

In one embodiment, the block of selecting the one or more working light sources from the plurality of light sources with different laser characteristics in accordance with the operating scenario information of the laser may further include: obtaining a preset light source laser characteristics matched with the operating scenario of the laser; and selecting the one or more working light sources with the same characteristics as the preset light source laser characteristics from the plurality of light sources with different laser characteristics. The one or more working light sources are light sources of the plurality of light sources that have the same characteristics as the preset light source laser characteristics.

In one embodiment, the laser characteristics can be selected from a group consisting of: wavelength, power, and beam shape. For example, the laser characteristics may include wavelengths, or wavelengths and powers.

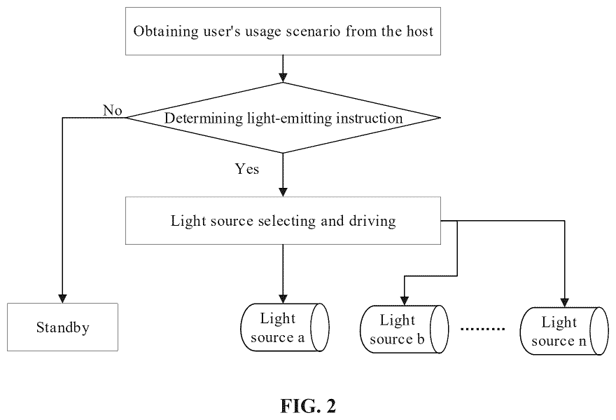

For better understanding, the following combines FIG. 2 to illustrate how to drive the light sources with different laser characteristics to emit light in this embodiment.

Referring to FIG. 2, the light sources may include laser diodes, the laser may include n laser diodes, namely a light source a, a light source b, . . . , a light source n. The laser obtains the operating scenario set by the user from a host, that is, the laser obtains the operating scenario information. When the laser does not receive a light-emitting instruction, the laser can be in a standby state. After the laser receives the light emitting instruction, objective light sources that meet a requirement of the operating scenario information among the light source a, the light source b, . . . , the light source n emit light.

The following provides examples of three operating scenarios of the laser.
(1) If the operating scenario information indicates the picture engraving and printing scenario, preset light sources can be fine-spot LD light sources. For example, the laser characteristics of the fine-spot LD light sources used in one embodiment are as follows: (1) power: 100 milliwatts; (2) voltage: 5.5 volts; (3) current: 0.225 amperes; (4) wavelength: 450 nanometers; (5) beam divergence angle: 6.5 degrees to 22.5 degrees. Thus, the laser may select one or more matching fine-spot LD light sources from the plurality of light sources with different laser characteristics as the one or more working light sources to emit light, which can achieve an excellent engraving effect.
(2) If the operating scenario information indicates the cutting scenario, the preset light sources can be high power LD light sources. For example, the laser characteristics of the high power LD light source used in one embodiment are as follows: (1) power: 5000 milliwatts; (2) voltage: 4.3 volts; (3) current: 3 amperes; (4) wavelength: 447 nanometers; (5) beam divergence angle: 9 degrees to 49 degrees. Thus, the laser may selects one or more matching high power LD light sources from the plurality of light sources with different laser characteristics as the one or more working light sources to emit light, which can achieve a desired cutting effect.
(3) If the operating scenario information indicates the glass engraving scenario, the preset light sources can be ultraviolet LD light sources. For example, the laser characteristics of the ultraviolet LD light sources used in one embodiment are as follows: (1) power: 155 milliwatts; (2) voltage: 5 volts; (3) current: 0.13 amperes; (4) wavelength: 405 nanometers; (5) beam divergence angle: 9 degrees to 19 degrees. Thus, the laser may select one or more matching ultraviolet LD light sources from the plurality of light sources with different laser characteristics as the one or more working light sources to emit light, which can achieve an excellent glass engraving effect.

It can be understandable that the laser characteristics of the fine-spot LD light sources, the high power LD light sources, and the ultraviolet LD light sources mentioned above are all feasible implementation methods. In a practical application, there is no limitation on parameter values of the laser characteristics of each light source, the laser characteristics can be set or selected in accordance with an actual need of the working scenario.

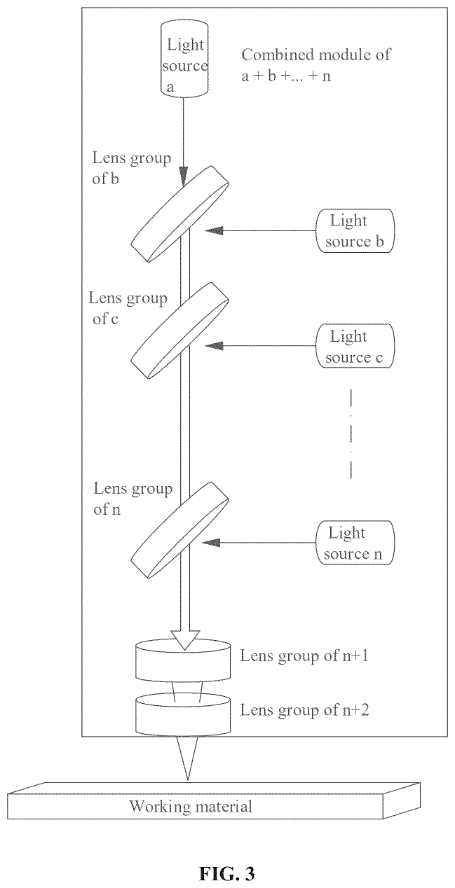

FIG. 3 illustrates a universal combined structural of n light sources of a laser module.
(1) The laser is formed by n LD light sources with different laser wavelength band characteristics and different powers in accordance with actual design requirements.
(2) For horizontally-emitting LD light sources from b to n, each LD light source corresponds to a lens group from b to n.
(3) The lens groups from b to n adjust direction and angle of light emitted by the LD light sources, and finally converge light rays of each LD light source to the same vertically-emitting light path.
(4) A lens group (n+1) focuses parallel thick light rays, and a focal point can fall on a working material.
(5) A lens group (n+2) prevents dust from entering an inside of a lens cavity of the laser module from below.
(6) Different working materials have different absorption rates for lasers with different laser wavelength band characteristics. The laser module may drive corresponding LD light sources to work in accordance with a material usage scenario set by the user to achieve an excellent engraving and cutting effects.
In block 103: operating states of the one or more working light sources are monitored and alarm information is sent in response to the operating states of the one or more working light sources including an abnormal state.

In one embodiment, the alarm information may be in a form of voice broadcasts, text prompts, ringing bells, etc. The embodiments do not limit a presentation form of the alarm information, which can be set in accordance with an actual requirement.

In one embodiment, the laser is provided with a temperature sensor. The temperature sensor may monitor a working temperature of the one or more working light sources, and send the alarm information when the working temperature of the one or more working light source is abnormal.

In one embodiment, how the laser monitors the operating states of the one or more working light sources and how to determine the abnormal operating state will be described in detail later. To avoid repetition, they will not be described here.

Compared with the prior art, the embodiments of the present application have the following advantages. The laser is formed by the plurality of light sources with different laser characteristics. By obtaining the operating scenario information of the laser, the operating scenario of a laser machine including the laser can be determined, such as the operating scenario may be picture engraving, cutting, glass engraving, etc. Then, the one or more working light sources can be selected from the plurality of light sources with different laser characteristics in accordance with the operating scenario information, so that optimal engraving and cutting effects for the operating scenario can be achieved, and a practicality of the laser can be improved. By monitoring the operating state of the one or more working light sources and sending the alarm information when one or more working light sources are abnormal, the abnormal working light sources can be promptly dealt with, thereby avoiding irreversible damage caused by the working light sources remaining in the abnormal operating state for a long time, and improving the service life of the laser.

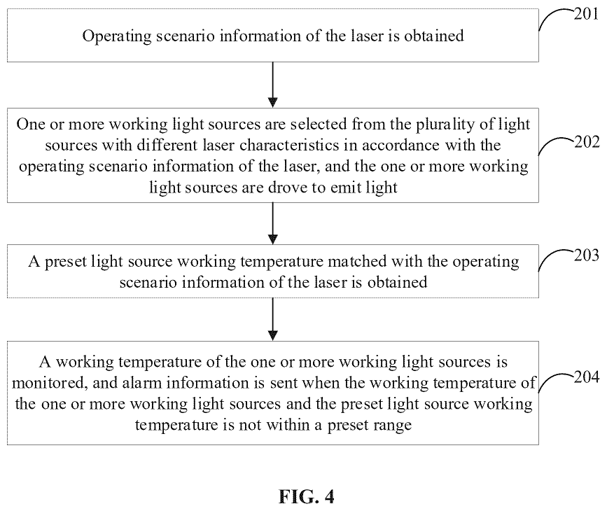

FIG. 4 is a working flowchart diagram of the laser in accordance with an embodiment of the present application. This embodiment is an explanatory illustration of the preceding embodiment, specifically explaining: how to monitor the working states of the one or more working light sources and how to determine whether the working states are abnormal.

This embodiment can be applied in the laser. As shown in FIG. 4, the working flowchart may includes the following blocks.
In block 201: operating scenario information of the laser is obtained.
In block 202: one or more working light sources are selected from the plurality of light sources with different laser characteristics in accordance with the operating scenario information of the laser, and the one or more working light sources are drove to emit light.

Blocks 201 to 202 of this embodiment are similar to blocks 101 to 102 of the preceding embodiment. To avoid repetition, they will not be described here.
In block 203: a preset light source working temperature matched with the operating scenario information of the laser is obtained.

In one embodiment, the preset light source working temperature of the laser is different under different operating scenarios. For example, in the picture engraving and printing scenario, the preset light source working temperature is between 40 degrees celsius to 55 degrees celsius; in the cutting scenario, the preset light source working temperature is between 40 degrees celsius to 70 degrees celsius; in the glass engraving scenario, the preset light source working temperature is between 40 degrees celsius to 55 degrees celsius.

It can be understood that value ranges of the preset light source working temperature in the picture engraving and printing scenario, the cutting scenario, and the glass engraving scenario are all feasible implementation manners. In a practical application, the value ranges of p the preset light source working temperature in each scenario are not limited, and can be set in accordance with the actual requirement of the working scenario.

In one embodiment, the laser may store the preset light source working temperature matched with the working scenario information. After the laser obtains the working scenario information, the laser can directly obtain the corresponding preset light source working temperature in accordance with the working scenario information.
In block 204: a working temperature of the one or more working light sources is monitored, and alarm information is sent when the working temperature of the one or more working light sources and the preset light source working temperature is not within a preset range.

In one embodiment, when the working temperature is lower than the preset light source working temperature, it may affect a working effect of the laser. When the working temperature is higher than the preset light source working temperature, it may cause damage to the working light sources. Therefore, by sending the alarm information when a difference between the working temperature of the one or more working light sources and the preset light source working temperature is not within the preset range. That is, whether the working temperature is lower or higher than the preset light source working temperature, the alarm information can be sent, which improves the reliability of the laser.

In one embodiment, the value of the preset range is related to the laser characteristics of the preset light sources (light sources matched with the operating scenario). When the preset light sources are engraving laser diodes, the preset range is greater than or equal to 30 degrees celsius and less than or equal to 60 degrees celsius; when the preset light sources are cutting laser diodes, the preset range is greater than or equal to 30 degrees celsius and less than or equal to 80 degrees celsius; when the preset light sources are glass engraving laser diodes, the preset range is greater than or equal to 30 degrees celsius and less than or equal to 60 degrees celsius. This setting of such range can ensure the working effect of the laser, avoiding damage to the working light sources due to excessive temperature, and improving the reliability of the laser.

It can be understood that the values of the preset ranges in the above examples, which are given when the preset light sources are the engraving laser diodes, the cutting laser diodes, and g the lass engraving laser diodes respectively, are all feasible implementation manners. In a practical application, the value of the preset range corresponding to the preset light sources with different laser characteristics are not limited, and can be set in accordance with the actual needs of the working scenarios.

Compared with the prior art, the embodiments of the present application have the following advantages. The laser is formed by the plurality of light sources with different laser characteristics. By obtaining the operating scenario information of the laser, the operating scenario of a laser machine including the laser can be determined, such as the operating scenario may be picture engraving, cutting, glass engraving, etc. Then, the one or more working light sources can be selected from the plurality of light sources with different laser characteristics in accordance with the operating scenario information, so that optimal engraving and cutting effects for the operating scenario can be achieved, and a practicality of the laser can be improved. By monitoring the operating state of the one or more working light sources and sending the alarm information when one or more working light sources are abnormal, the abnormal working light sources can be promptly dealt with, thereby avoiding irreversible damage caused by the working light sources remaining in the abnormal operating state for a long time, and improving the service life of the laser.

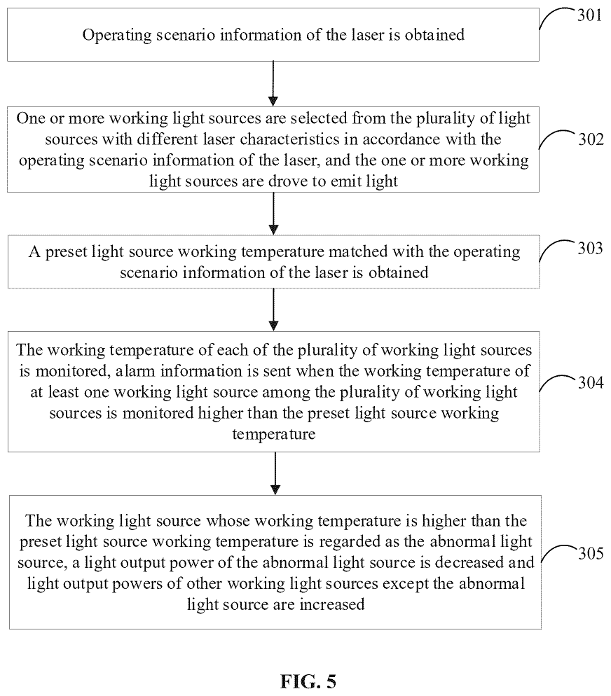

FIG. 5 is a working flowchart diagram of the laser in accordance with another embodiment of the present application. This embodiment is an improvement of the previous embodiment. An improvement of this embodiment may refer to a plurality of working light sources. When there exists one or more abnormal light sources, the light output power of each working light source may be dynamically adjusted to maintain the stability of the overall working temperature of the plurality of working light sources. While ensuring the working effect of the laser, the effect of safety protection for the plurality of working light sources can be achieved.

This embodiment can be applied in the laser. As shown in FIG. 5, the working flowchart may includes the following blocks.
In block 301: operating scenario information of the laser is obtained.
In block 302: one or more working light sources are selected from the plurality of light sources with different laser characteristics in accordance with the operating scenario information of the laser, and the one or more working light sources are drove to emit light.
In block 303: a preset light source working temperature matched with the operating scenario information of the laser is obtained.

Blocks 301 to 303 of this embodiment are similar to blocks 201 to 203 of the preceding embodiment. To avoid repetition, they will not be described here.
In block 304: the working temperature of each of the plurality of working light sources is monitored, alarm information is sent when the working temperature of at least one working light source among the plurality of working light sources is monitored higher than the preset light source working temperature.

In one embodiment, the plurality of working light sources have the same laser characteristics. Through this kind of setting, on the one hand, it can improve the working effect of the laser; on the other hand, when one or more working light sources malfunction, such as having an excessively high temperature, it can dynamically adjust the light output power of each working light source to maintain the stability of the overall working temperature of the plurality of working light sources, thus improving the reliability of the laser.

In one embodiment, a temperature sensor may be embedded beside each light source bracket to monitor the working temperature of each light source in real time. Once it is detected that a certain working light source is overheated, the abnormal working light source may be controlled to stop emitting light, and the alarm information may be sent to ensure the safety of the user and prevent the abnormal working light source from being damaged, which improves the maintainability of the laser.
In block 305: the working light source whose working temperature is higher than the preset light source working temperature is regarded as the abnormal light source, a light output power of the abnormal light source is decreased and light output powers of other working light sources except the abnormal light source are increased.

In one embodiment, if the laser detects that the working temperature of a certain working light source is relatively high, the laser can control this working light source to appropriately reduce its light output power. The laser can further increase the light output powers of other working light sources with the same light source characteristics and lower temperatures, so as to maintain the stability of the overall working temperature of the laser, ensure the working effect of the laser, and achieve an effect of dynamic power compensation.

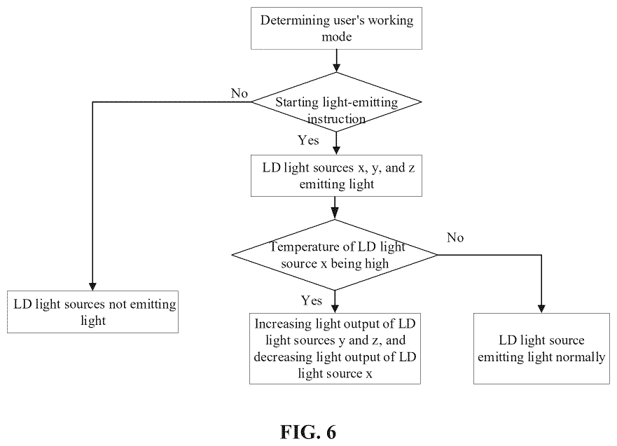

For better understanding, the following combines FIG. 6 to explain how to perform dynamic power compensation for the working light sources in this embodiment. FIG. 6 illustrates a flowchart of the dynamic power compensation for the working light sources.
(1) After the laser determines the working scenario, the laser drives corresponding LD light sources x, y, and z with the same laser characteristics to emit light.
(2) Before the laser receives a light emitting instruction, the laser remains in the standby state, and all LD light sources do not emit light.
(3) After the LD light sources start to emit light, the laser monitors the working temperature of each LD light source.
(4) When the laser detects the working temperature of the LD light source x is relatively high, the light output power of the LD light source x is controlled to reduce. At the same time, the light output powers of the other two LD light sources y and z are controlled to increase, so that whole LD light sources can operate at an optimal working temperature.

Compared with the prior art, the embodiments of the present application have the following advantages. The laser is formed by the plurality of light sources with different laser characteristics. By obtaining the operating scenario information of the laser, the operating scenario of a laser machine including the laser can be determined, such as the operating scenario may be picture engraving, cutting, glass engraving, etc. Then, the one or more working light sources can be selected from the plurality of light sources with different laser characteristics in accordance with the operating scenario information, so that optimal engraving and cutting effects for the operating scenario can be achieved, and a practicality of the laser can be improved. By monitoring the operating state of the one or more working light sources and sending the alarm information when one or more working light sources are abnormal, the abnormal working light sources can be promptly dealt with, thereby avoiding irreversible damage caused by the working light sources remaining in the abnormal operating state for a long time, and improving the service life of the laser.

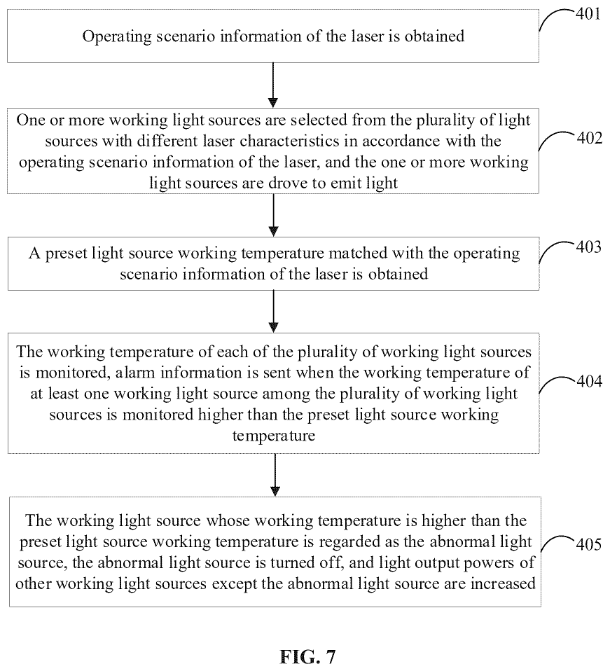

FIG. 7 is a working flowchart diagram of the laser in accordance with another embodiment of the present application. This embodiment is an improvement of the previous embodiment. An improvement of this embodiment may refer to a plurality of working light sources. When there exists one or more abnormal light sources, the one or more abnormal light sources may be turned off and light output powers of other working light sources except the abnormal light sources may be increased to maintain the stability of the overall working temperature of the plurality of working light sources. While ensuring the working effect of the laser, the effect of safety protection for the plurality of working light sources can be achieved.

This embodiment can be applied in the laser. As shown in FIG. 7, the working flowchart may includes the following blocks.
In block 401: operating scenario information of the laser is obtained.
In block 402: one or more working light sources are selected from the plurality of light sources with different laser characteristics in accordance with the operating scenario information of the laser, and the one or more working light sources are drove to emit light.
In block 403: a preset light source working temperature matched with the operating scenario information of the laser is obtained.
In block 404: the working temperature of each of the plurality of working light sources is monitored, alarm information is sent when the working temperature of at least one working light source among the plurality of working light sources is monitored higher than the preset light source working temperature.

Blocks 401 to 404 of this embodiment are similar to blocks 301 to 304 of the preceding embodiment. To avoid repetition, they will not be described here.
In block 405: the working light source whose working temperature is higher than the preset light source working temperature is regarded as the abnormal light source, the abnormal light source is turned off, and light output powers of other working light sources except the abnormal light source are increased.

In one embodiment, by turning off the abnormal light source, the abnormal light source can be cooled down at a fast speed, and damage to the abnormal light source can be avoided as much as possible.

Compared with the prior art, the embodiments of the present application have the following advantages. The laser is formed by the plurality of light sources with different laser characteristics. By obtaining the operating scenario information of the laser, the operating scenario of a laser machine including the laser can be determined, such as the operating scenario may be picture engraving, cutting, glass engraving, etc. Then, the one or more working light sources can be selected from the plurality of light sources with different laser characteristics in accordance with the operating scenario information, so that optimal engraving and cutting effects for the operating scenario can be achieved, and a practicality of the laser can be improved. By monitoring the operating state of the one or more working light sources and sending the alarm information when one or more working light sources are abnormal, the abnormal working light sources can be promptly dealt with, thereby avoiding irreversible damage caused by the working light sources remaining in the abnormal operating state for a long time, and improving the service life of the laser.

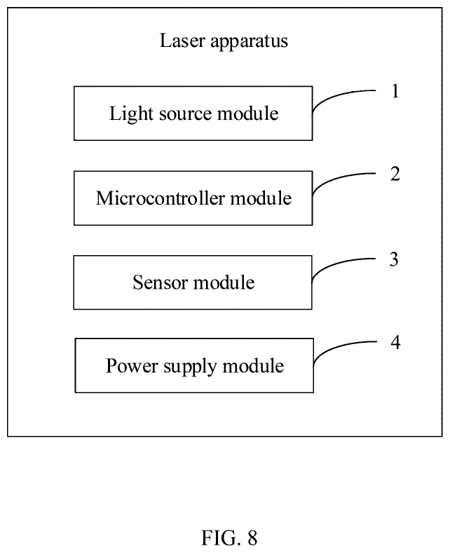

Referring to FIG. 8, which is a schematic diagram of a hardware structure of a laser apparatus in accordance with an embodiment of the present application. As shown in FIG. 8, the laser may include a light source module 1, a microcontroller module 2, a sensor module 3, and a power supply module 4. The light source module 1 includes a plurality of light sources with different laser characteristics. The microcontroller module 2 is configured for obtaining operating scenario information of the laser, selecting one or more working light sources from the plurality of light sources with different laser characteristics in accordance with the operating scenario information of the laser, and driving the one or more working light sources to emit light. The sensor module 3 is configured for monitoring signals that characterize operating states of the one or more working light sources and sending the signals to the microcontroller module 2. The microcontroller module 2 is further configured for sending alarm information in response to the operating states of the one or more working light sources including an abnormal state. The power supply module 4 is configured for supplying power to the light source module 1, the microcontroller module 2, and the sensor module 3.

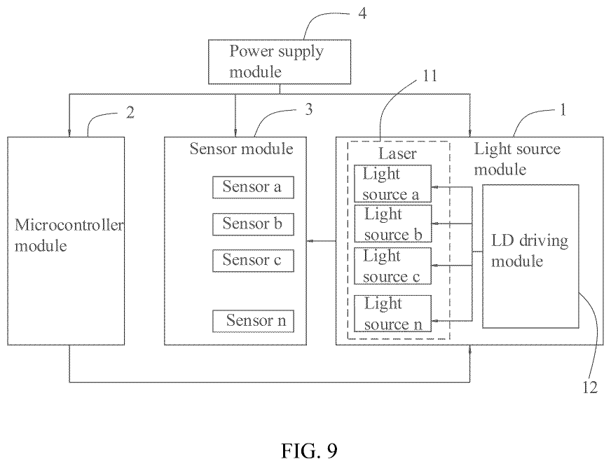

For better understanding, the following combines FIG. 9 to explain a working principle of the laser apparatus in this embodiment. As shown in FIG. 9, it is a module diagram of the laser.
(1) The power supply module supply power to the microcontroller module, the sensor module, and the LD light source module.
(2) The microcontroller module serves as a brain of the laser. The microcontroller module monitors the operating state of each LD light source in the LD light source module and controls the light output power of each LD light source.
(3) The sensor module detects the operating state of each LD light source. Each LD light source corresponds to a sensor. Detecting signals of the sensor may be transmitted to the microcontroller module to achieve detecting the operating state.
(4) Under the control of the microcontroller module, the LD light source module turns on specified LD light sources to emit light at a set power.
(5) The maximum cutting capacity of the LD light source module is a sum of the powers of all LD light sources.
(6) During light emitting process of the LD light sources, once the microcontroller module detects an abnormal temperature of a certain LD light source, the microcontroller module can turn off the abnormal LD light source and output alarm information.

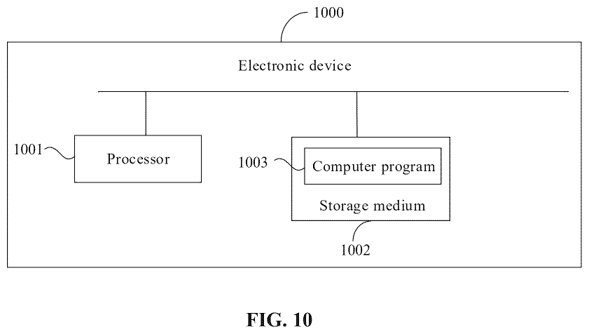

FIG. 10 illustrates a schematic structural diagram of an electronic device 1000 in accordance with an embodiment of the present application.

As shown in FIG. 10, the electronic device 1000 may include a processor 1001, a storage medium 1002. The storage medium 1002 is configured to store one or more computer programs 1003. The one or more computer programs 1003 are configured to be executed by the processor 1001. The one or more computer programs 1003 include instructions, and the instructions is capable of being executed by the electronic device 1000 to implement the laser working method.

It can be understood that the structure shown in this embodiment does not constitute a limitation on the electronic device 1000. In other embodiments, the electronic device 1000 may include more or fewer components than shown in FIG. 10, or combine some components, or separate some components, or arrange different components.

The processor 1001 may include one or more processing units, for example, the processor 1001 may include an application processor (AP), a modem, a graphics processing unit (GPU), an image signal processor (ISP), a controller, a video codec, a digital signal processor (DSP), a baseband processor, and/or a neural network processing unit (NPU), etc. Different processing units may be independent components, or may be integrated in one or more processors.

A memory may also be integrated in the processor 1001 for storing instructions and data. In one embodiment, the memory integrated in processor 1001 may be a cache memory. The memory may store instructions or data that the processor 1001 has just used or recycled. If the processor 1001 needs to use the instruction or data again, it can be directly recalled from the memory, and a repeated store and read is avoided. A waiting time of the processor 1001 is reduced, and an efficiency of the system is improved.

In one embodiment, the processor 1001 may include one or more interfaces. The interfaces may include an inter-integrated circuit (I2C) interface, an inter-integrated circuit sound (12S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, and/or a universal serial bus (USB) interface, etc.

In one embodiment, the storage medium 1002 may include a high-speed random access memory, and may also include a non-volatile memory, such as a hard disk, an internal memory, a plug-in hard disk, a smart media card (SMC), a secure digital (SD) card, a flash card, at least one magnetic disk memory, a flash memory, or other non-volatile solid-state memory.

The present application further provides a computer storage medium, the computer storage medium stores computer instructions, when the computer instructions run on an electronic device, the electronic device is caused to execute the above-mentioned content sharing method.

The electronic device and the computer storage medium in this embodiment are used to execute the above-mentioned method, so beneficial effects that is capable of being achieved can be referred to beneficial effects of the above-mentioned method, which will not be repeated herein.

In practical applications, the above-mentioned functions can be allocated to different functional modules to complete in accordance with actual requirements. That is, an internal structure of a device is divided into different functional modules to complete all or part of the above-mentioned functions.

In the several embodiments provided in this application, it should be understood that the disclosed devices and methods may be implemented in other ways. For example, the device embodiments described above are only illustrative. For example, the division of the modules or units is only a logical function division. In an actual implementation, there may include other division ways. For example, a plurality of units or components can be combined or can be integrated into another device, or some features can be omitted, or not be implemented. In the other hand, the coupling or direct coupling or communication connection shown or discussed may be through some interfaces, and the indirect coupling or communication connection of devices or units may be in electrical, mechanical or other forms.

The unit described as a separate component may or may not be physically separated, and a component displayed as a unit may be one physical unit or a plurality of physical units. That is, it may be located in one place, or may be distributed to a plurality of different places. Part or all of the units can be selected in accordance with actual requirements to achieve the purpose of the solution of this embodiment.

In addition, functional units in each embodiment of the present application may be integrated into one processing unit, each functional unit may also exist separately and physically, or two or more units may be integrated into one unit. The above-mentioned integrated units can be implemented in a form of hardware or in a form of software functional units.

If the integrated units are realized in the form of software function units and sold or used as an independent product, the integrated units can be stored in a readable storage medium. Based on this understanding, the technical solution of the embodiment of the present application is essentially or the part that contributes to the prior art, or all or part of the technical solution can be embodied in the form of a software product, and the software product is stored in a storage medium. The software product includes several instructions to make a device (may be a single-chip microcomputer, a chip, etc.) or a processor execute all or part of steps of the methods described in the various embodiments of the present application. The storage medium may include: a USB flash disk, a mobile hard disk, a read-only memory (ROM), a random access memory (RAM), a magnetic disk, an optical disk, and other various media that can store program codes.

The above is only a specific implementation of the present application, a protection scope of the present application is not limited thereto, and any changes or replacements within the technical scope disclosed in the present application should be covered within the protection scope of the present application.

1. A laser working method, comprising:
obtaining operating scenario information of a laser, wherein the laser is provided with a plurality of light sources with different laser characteristics;
selecting one or more working light sources from the plurality of light sources with different laser characteristics in accordance with the operating scenario information of the laser, and driving the one or more working light sources to emit light; and
monitoring operating states of the one or more working light sources and sending alarm information in response to the operating states of the one or more working light sources comprising an abnormal state.

2. The laser working method as claimed in claim 1, wherein after obtaining the operating scenario information of the laser, the method further comprises:
obtaining a preset light source working temperature matched with the operating scenario information of the laser;
monitoring the operating states of the one or more working light sources and sending the alarm information in response to the operating states of the one or more working light sources comprising the abnormal state comprises:
monitoring a working temperature of the one or more working light sources; and
sending the alarm information when the working temperature of the one or more working light sources and the preset light source working temperature is not within a preset range.

3. The laser working method as claimed in claim 2, wherein a plurality of working light sources are selected, monitoring the working temperature of the one or more working light sources comprises:
monitoring the working temperature of each of the plurality of working light sources;
sending the alarm information when the working temperature of the one or more working light sources and the preset light source working temperature is not within the preset range comprises:
sending the alarm information when the working temperature of at least one working light source among the plurality of working light sources is monitored higher than the preset light source working temperature.

4. The laser working method as claimed in claim 3, wherein after sending the alarm information, the method further comprises:
regarding the working light source whose working temperature is higher than the preset light source working temperature as an abnormal light source; and
decreasing a light output power of the abnormal light source and increasing light output powers of other working light sources except the abnormal light source.

5. The laser working method as claimed in claim 3, wherein after sending the alarm information, the method further comprises:
regarding the working light source whose working temperature is higher than the preset light source working temperature as an abnormal light source; and
turning off the abnormal light source and increasing light output powers of other working light sources except the abnormal light source.

6. The laser working method as claimed in claim 1, wherein selecting the one or more working light sources from the plurality of light sources with different laser characteristics in accordance with the operating scenario information of the laser comprises:
obtaining a preset light source laser characteristics matched with the operating scenario information of the laser; and
selecting the one or more working light sources with the same characteristics as the preset light source laser characteristics from the plurality of light sources with different laser characteristics.

7. The laser working method as claimed in claim 1, wherein the light sources are provided with laser diodes, the laser characteristics are selected from a group consisting of: wavelength, power, and beam shape.

8. (canceled)

9. A non-transitory computer storage medium comprising computer instructions, wherein when the computer instructions run on an electronic device, the electronic device is caused to execute a laser working method, the laser working method comprises:
obtaining operating scenario information of a laser, wherein the laser is provided with a plurality of light sources with different laser characteristics;
selecting one or more working light sources from the plurality of light sources with different laser characteristics in accordance with the operating scenario information of the laser, and driving the one or more working light sources to emit light; and
monitoring operating states of the one or more working light sources and sending alarm information in response to the operating states of the one or more working light sources comprising an abnormal state.

10. An electronic device, comprising:
one or more processors; and
a non-transitory storage medium, configured to store one or more instructions, wherein when the one or more instructions run on the one or more processors, to cause the one or more processors to execute a laser working method, the laser working method comprises:
obtaining operating scenario information of a laser, wherein the laser is provided with a plurality of light sources with different laser characteristics;
selecting one or more working light sources from the plurality of light sources with different laser characteristics in accordance with the operating scenario information of the laser, and driving the one or more working light sources to emit light; and
monitoring operating states of the one or more working light sources and sending alarm information in response to the operating states of the one or more working light sources comprising an abnormal state.

11. The electronic device as claimed in claim 10, wherein after obtaining the operating scenario information of the laser, the electronic device is further caused to execute:
obtaining a preset light source working temperature matched with the operating scenario information of the laser;
monitoring the operating states of the one or more working light sources and sending the alarm information in response to the operating states of the one or more working light sources comprising the abnormal state comprises:
monitoring a working temperature of the one or more working light sources; and
sending the alarm information when the working temperature of the one or more working light sources and the preset light source working temperature is not within a preset range.

12. The electronic device as claimed in claim 11, wherein a plurality of working light sources are selected, monitoring the working temperature of the one or more working light sources comprises:
monitoring the working temperature of each of the plurality of working light sources;
sending the alarm information when the working temperature of the one or more working light sources and the preset light source working temperature is not within the preset range comprises:
sending the alarm information when the working temperature of at least one working light source among the plurality of working light sources is monitored higher than the preset light source working temperature.

13. The electronic device as claimed in claim 12, wherein after sending the alarm information, the electronic device is further caused to execute:
regarding the working light source whose working temperature is higher than the preset light source working temperature as an abnormal light source; and
decreasing a light output power of the abnormal light source and increasing light output powers of other working light sources except the abnormal light source.

14. The electronic device as claimed in claim 12, wherein after sending the alarm information, the electronic device is further caused to execute:
regarding the working light source whose working temperature is higher than the preset light source working temperature as an abnormal light source; and
turning off the abnormal light source and increasing light output powers of other working light sources except the abnormal light source.

15. The electronic device as claimed in claim 10, wherein selecting the one or more working light sources from the plurality of light sources with different laser characteristics in accordance with the operating scenario information of the laser comprises:
obtaining a preset light source laser characteristics matched with the operating scenario information of the laser; and
selecting the one or more working light sources with the same characteristics as the preset light source laser characteristics from the plurality of light sources with different laser characteristics.

16. The electronic device as claimed in claim 10, wherein the light sources are provided with laser diodes, the laser characteristics are selected from a group consisting of: wavelength, power, and beam shape.
